(19) United States
(12) Patent Application Publication
(10) Pub. No.: US 2004/0196420 A1
(43) Pub. Date: Oct. 7, 2004

(54) Display apparatus with mirror function

(76) Inventors: Jie-Farn Wu, Miaoli (TW); Yi-Sheng Wang, Sanchung City (TW); Ching-Hsien Hsu, Taipei (TW); Ying-Yu Lu, Taichung (TW)

Correspondence Address: BIRCH STEWART KOLASCH & BIRCH, PO BOX 747, FALLS CHURCH, VA, 22040-0747, US

(21) Appl. No.: 10/803,962

(22) Filed: Mar. 19, 2004

(30) Foreign Application Priority Data
Mar. 21, 2003 (TW) 092106426
Mar. 20, 2003 (TW) 09220439
Mar. 24, 2003 (TW) 092106557

(51) Int. Cl. G02F 1/1335

(52) U.S. Cl. 349/114

(57) ABSTRACT

A display apparatus with a mirror function comprises a display and a semi-reflecting layer. The display includes a transparent substrate. The semi-reflecting layer is disposed on one surface of the transparent substrate. Furthermore, another display apparatus with a mirror function comprises a transparent substrate, a first electrode, a second electrode, an organic light-emitting portion, and a mirror plate. In this case, the first electrode is disposed on one side of the transparent substrate. The second electrode is disposed on the first electrode. The organic light-emitting portion is disposed between the first and second electrodes. The mirror plate is positioned on an opposite side of the transparent substrate, which is opposite to the side disposed with the first electrode.

### BACKGROUND OF THE INVENTION

1. Field of the Invention

The invention relates to a display apparatus with a mirror function and, in particular, to a display apparatus with a mirror function that has a semi-reflecting layer and has a function of generating information and/or images.

2. Description of the Related Art

A variety of technologies and display apparatus have been developed with the broadening of product applications in the information age. From the introduction of black-and-white monochromatic, color to future three-dimensional display; from the cathode ray tube (CRT), flat panel to portable, foldable or even large-screen displays, it is obvious that the development of display apparatus is to make them more human-friendly.

From the pragmatic point of view, the applications of the display apparatus can be further expanded if it has a reflecting mirror function. To achieve such an effect, a conventional display apparatus is attached with a reflecting film onto a screen of the display apparatus. Thus, the display apparatus renders dual functions of display and reflection. However, since the reflectance of the reflecting film is inversely proportional to its transmittance (i.e. the better its reflectance is, the worse its transmittance is), therefore, those display apparatus attached with reflecting films generally have decreased brightness. Moreover, since the reflecting film is attached onto the screen with an adhesive, which has limited lifetime, the attached reflecting film is not ideal for long-term usages.

Therefore, it is a subjective of the invention to provide an apparatus with a mirror function that can solve the above-mentioned problems.

On the other hand, mirrors have the function of reflecting images, and are therefore a necessary tool of our daily life. Recently, industries have combined the mirror with display, so that the mirror can have dual functions including the image displaying and image reflecting.

In present technology, the conventional display mirror includes a mirror and a light-emitting diode (LED) disposed behind the mirror. However, since the resolution of the entire image is insufficient, the conventional display mirror is not suitable for displaying the image of high information density. Furthermore, since the emitting chip of the LED is modulated, the size of the LED is increased, which results in the display mirror losing the characteristic of flat and laminar.

Besides, an additional conventional display mirror includes a mirror and a liquid crystal display (LCD) disposed behind the mirror. In such a case, since the liquid crystal material of the LCD cannot emit light and the LCED requires extra backlight to emit light and to display images, the luminescence efficiency, contrast and viewing angle of the LCD is imperfect. The LCD has a complex structure and includes backlight, color filters, and polarizer, so that the manufacturing cost of the display mirror with the LCD is increased.

Accompanying with the broadening of the application field and the increase of the content of transported information, the conventional mirror with displaying function cannot satisfy the requirements of image resolution and information quantity. In viewing this problem, a display mirror for solving the drawbacks of the convention technology is desired.

It is therefore another subjective of the invention to provide a display apparatus with a mirror function, which can solve the above-mentioned problems.

### SUMMARY OF THE INVENTION

In view of the foregoing, the invention is to provide a display apparatus with a mirror function, which can reflect images and has a displaying function.

A display apparatus with a mirror function of the invention includes a display and a semi-reflecting layer. In the invention, the display has a transparent substrate, and the semi-reflecting layer is disposed on one side of the transparent substrate.

The display could be and not limited to an organic electroluminescent (OEL) display, an inorganic electroluminescent (EL) display, a light emitting diode (LED) display, a liquid crystal display (LCD), a plasma display panel (PDP), a vacuum fluorescent display (VFD), a field emission display (FED), and an electro-chromic display.

As described above, the invention has a semi-reflecting layer for producing mirror effects. When the display emits light or radiation, the display apparatus of the invention exhibits its display function. On the other hand, when the display does not emit light, the display apparatus of the invention exhibits the mirror function. Comparing to the prior art, the invention integrates the semi-reflecting layer in the planar structure of the display without using an adhesive so that the display apparatus has the dual functions of displaying and reflecting images. This does not only broaden the application scope of the display apparatus, but also makes the operations much easier for users. Since the semi-reflecting layer is disposed inside the display apparatus, the manufacturing process is simpler and cheaper. Therefore, the invention is suitable for mass production.

In an additional aspect, a display apparatus with a mirror function of the invention comprises a transparent substrate, a first electrode, a second electrode, an organic light-emitting zone and a mirror plate. In the invention, the first electrode is disposed on the transparent substrate, and the second electrode is disposed above the first electrode. The organic light-emitting zone is disposed between the first electrode and the second electrode. The mirror plate is disposed on one side of the transparent substrate, which is opposite to the side of the transparent substrate connected to the first electrode.

The light-emitting zone is an electroluminescence zone, which can be a single-layer or a multi-layer of an electroluminescence layer, an emitting media, and/or the likes. The emitting media, for example, is and is not limited to electroluminescence gas, or any other emitting media, which is excited by the electroluminescence gas.

As described above, the display apparatus with a mirror function of the invention combines the display and the mirror plate with semi-reflecting layer. When the light-emitting zone emits light, the display apparatus with a mirror function presents the function of displaying; otherwise, when the light-emitting zone does not emit light, the display apparatus with a mirror function presents the function of reflecting images. Compared with the conventional technology, the invention integrates the flat structures of the reflecting mirror plate and display, so that the display apparatus with a mirror function has dual functions of displaying and image reflecting. Therefore, the application field of the mirror is broadened, and the display apparatus with a mirror function is more convenient for user operations. Furthermore, the manufacturing process of the display apparatus with a mirror function of the invention is simpler and not expensive. Therefore, the invention is suitable for mass production.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of a display apparatus with a mirror function according to a first embodiment of the invention;

FIG. 2 is a schematic view of a display apparatus with a mirror function according to a second embodiment of the invention;

FIG. 3 is a schematic view of a display apparatus with a mirror function according to a third embodiment of the invention;

FIG. 4 is a schematic view showing an application of the display apparatus illustrated in FIG. 1;

FIG. 5 is a schematic view of a display apparatus with a mirror function according to a fourth embodiment of the invention;

FIG. 6 is another schematic view of a display apparatus with a mirror function according to the fourth embodiment of the invention;

FIGS. 7A and 7B are schematic views showing an application of the display apparatus with a mirror function according to the fourth embodiment of the invention; and

FIGS. 8A and 8B are schematic views showing a display apparatus with a mirror function according to a fifth embodiment of the invention.

### DETAILED DESCRIPTION OF THE INVENTION

The present invention will be apparent from the following detailed descriptions, which proceeds with reference to the accompanying drawings, wherein the same references relate to the same elements.

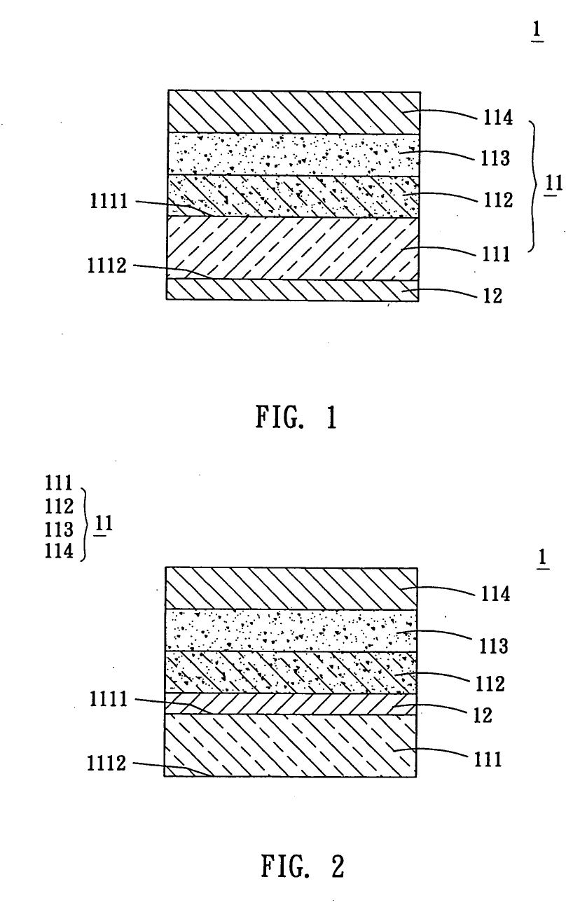

Referring to FIG. 1, a display apparatus with a mirror function 1 according to a first embodiment of the invention includes a display 11 and a semi-reflecting layer 12. The display 11 includes a transparent substrate 111. The semi-reflecting layer 12 is disposed on one side of the transparent substrate 111.

In this embodiment, the display 11 can be an OEL display. As shown in FIG. 1, the display 11 includes a transparent substrate 111, a first electrode 112, an organic functional layer 113, and a second electrode 114. The transparent substrate 111 has a first surface 1111 and a second surface 1112, which is opposite to the first surface 1111. The first electrode 112 is disposed on the first surface 1111 of the transparent substrate 111. The second electrode 114 is disposed above the first electrode 112, and the organic functional layer 113 is sandwiched between the first electrode 112 and the second electrode 114. The organic functional layer 113 is selected from hole-injecting materials, hole-transporting materials, electron-blocking materials, light-emitting materials, hole-blocking materials, electron-transporting materials, electron-injecting materials and the combinations.

In the current embodiment, the transparent substrate 111 can be a flexible or rigid substrate. The transparent substrate can also be a plastic or glass substrate. In particular, the flexible substrate or plastic substrate can be made of polycarbonate (PC), polyester (PET), cyclic olefin copolymer (COC), or metallocene-based cyclic olefin copolymer (mCOC).

Referring to FIG. 1, the first electrode 112 is disposed on the first surface 1111 of the transparent substrate 111. In the present embodiment, the first electrode 112 is disposed on the first surface 1111 by a sputtering method or an ion plating method. The first electrode 112 is usually used as an anode and made of a transparent conductive metal oxide, such as indium-tin oxide (ITO), aluminum-zinc oxide (AZO), or indium-zinc oxide (IZO).

Furthermore, the organic functional layer 113 in the current embodiment is disposed on the first electrode 112. The organic functional layer 113 usually contains a hole injection layer, a hole transporting layer, an electroluminescent layer, an electron transporting layer, and an electron injection layer (not shown). The hole injection layer comprises copper phthalocyanine (CuPc), the hole transporting layer comprises 4,4′-bis[N-(1-naphthyl)-N-phenylamino]biphenyl (NPB), the electron injection layer comprises lithium fluoride (LiF), and the electron transporting layer comprises tris(8-quinolinato-N1,08)-aluminum (Alq). Each layer of the organic functional layer 113 can be disposed upon the first electrode by utilizing evaporation, spin coating, ink jet printing, or printing. In addition, the light emitted from the organic functional layer 113 can be blue, green, red, white or other monochromatic light, or a color light as a combination of monochromatic lights.

With reference to FIG. 1, the second electrode 114 is disposed on the organic functional layer 113 by way of evaporation or sputtering. The material of the second electrode 114 can be aluminum, calcium, and magnesium-silver alloys. Of course, the material of the second electrode 114 can also be aluminum/lithium fluoride, or silver.

In this embodiment, the semi-reflecting layer 12 is disposed on one side of the transparent substrate 111, the second surface 1112 shown in FIG. 1. Alternatively, the semi-reflecting layer 12 can be disposed on the other side of the transparent substrate 111. As shown in FIG. 2, the semi-reflecting layer 12 of a second embodiment is disposed on the first surface 1111 of the transparent substrate 111. Moreover, the semi-reflecting layer 12 can be disposed on other side surfaces (not shown) of the transparent substrate to increase the lateral light utilization of the display 11.

In such cases, the semi-reflecting layer 12 is disposed on the first surface 1111 or the second surface 1112 by way of evaporation, sputtering, or ion plating. In the current embodiment, the semi-reflecting layer 12 is made of a metal or a dielectric material. The radiation transmittance of the semi-reflecting layer 12 is approximately between 10% and 90%.

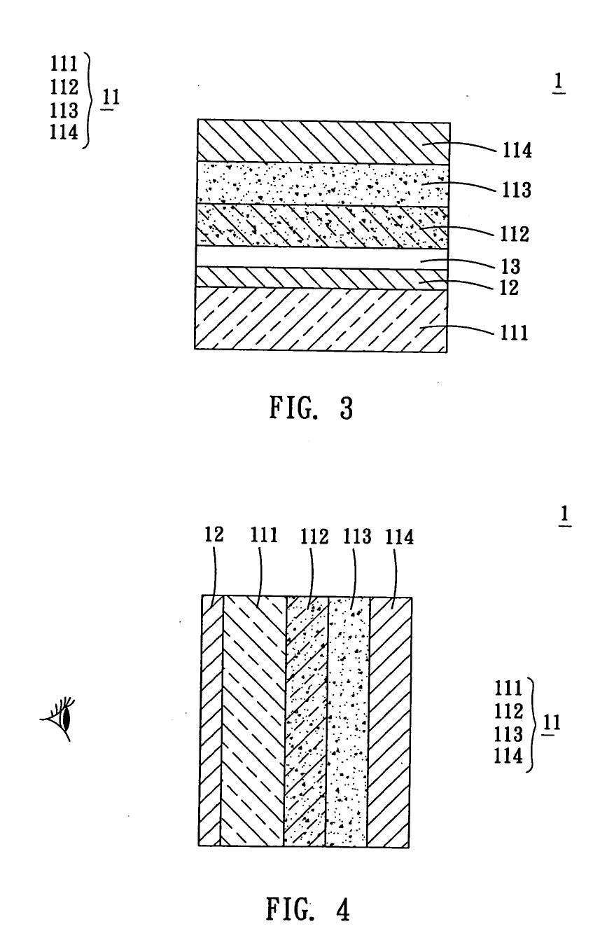

In a third embodiment, when the semi-reflecting layer 12 is made of a metal, an insulating layer 13 is further disposed between the semi-reflecting layer 12 and the first electrode 112, as shown in FIG. 3. The insulating layer is a transparent material for insulating the semi-reflecting layer 12 and the first electrode 112. This prevents the semi-reflecting layer 12 and the first electrode 112 from direct contact that causes short circuit.

FIG. 4 is a schematic view of FIG. 1. According to the invention, the user sees the screen (such as text, pictures or images) shown by the display when the display emits light or radiation. On the other hand, when the display does not emit light, the user sees reflection from the-screen.

As another example, if one uses the display apparatus with a mirror function of the invention as a TV inside a room, it can also be used as a mirror. This does not only save the user money for purchasing a mirror and space for decorating the mirror, but the room design can also be made better. Since the OEL display does not have the limitation of viewing angles, this advantage further increases the practical applications of the invention.

The display of the invention can be an organic electroluminescent (OEL) display, an inorganic electroluminescent (EL) display, a light emitting diode (LED) display, a liquid crystal display (LCD), a plasma display panel (PDP), a vacuum fluorescent display (VFD), a field emission display (FED), or an electro-chromic display.

When the display is an LED display, the transparent substrate includes a transparent cover-cap for encapsulating.

The display apparatus with a mirror function of the invention includes a semi-reflecting layer to produce mirror effects. When the display emits light or radiation, the display apparatus exhibits its display function. On the other hand, when the display does not emit light, the display apparatus exhibits the mirror function. In comparison with the prior art, the invention integrates the semi-reflecting layer in the planar structure of the display without any adhesive, so that the display apparatus has the dual functions of displaying and reflecting images. This does not only broaden the application scope of the display apparatus, but also makes the operations much easier for users. Furthermore, since the semi-reflecting layer is disposed in the display apparatus of the invention, the manufacturing process is simpler and cheaper. Therefore, the invention is suitable for mass production.

Besides, a display apparatus with a mirror function of the invention includes a transparent substrate, a first electrode, a second electrode, an organic light-emitting portion and a mirror plate. In this case, the first electrode is disposed on the transparent substrate, and the second electrode is disposed above the first electrode. The organic light-emitting portion is disposed between the first electrode and the second electrode. The mirror plate is disposed on one side of the transparent substrate, wherein the opposite side of the transparent substrate is connected to the first electrode.

In addition, a display apparatus with a mirror function of the invention comprises a transparent substrate, a first electrode, a second electrode, an organic light-emitting zone and a mirror plate. In such a case, the first electrode is disposed on the transparent substrate, and the second electrode is disposed above the first electrode. The organic light-emitting zone is disposed between the first electrode and the second electrode. The mirror plate is disposed on one side of the transparent substrate, wherein the opposite side of the transparent substrate is connected to the first electrode.

The light-emitting zone is an electroluminescence zone, which can be a single-layer or a multi-layer of an electroluminescence layer, an emitting media, and/or the likes. The emitting media, for example, is and is not limited to electroluminescence gas, or any other emitting media, which is excited by the electroluminescence gas.

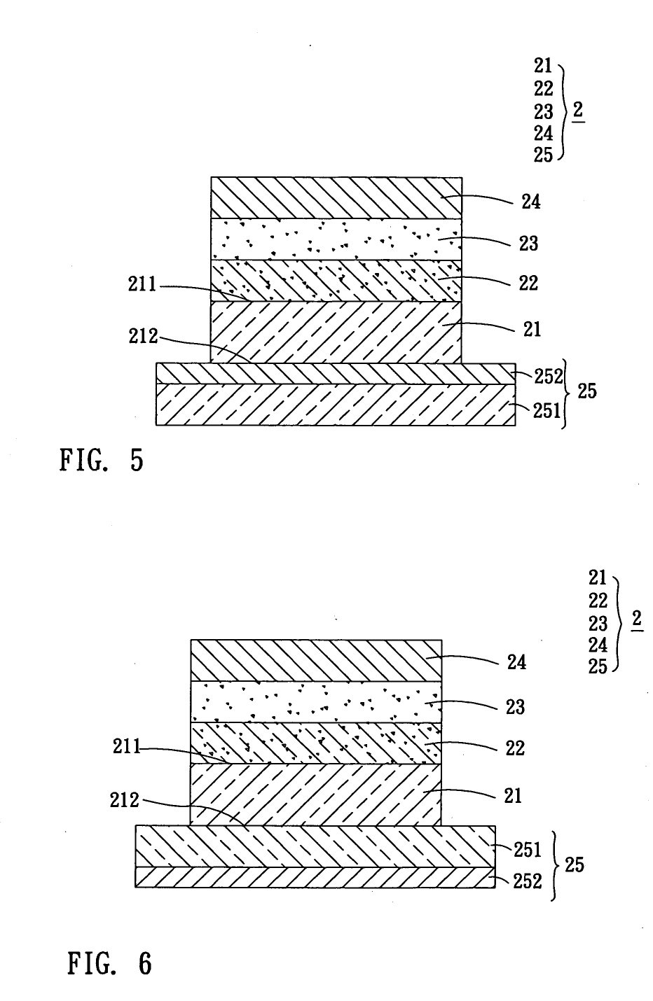

With reference to FIG. 5, a display apparatus with a mirror function 2 according to a fourth embodiment of the invention comprises a transparent substrate 21, a first electrode 22, an organic light-emitting portion 23, a second electrode 24, and a mirror plate 25. In this embodiment, the transparent substrate 21 has a first surface 211 and a second surface 212 opposite the first surface 211. The first electrode 22 is disposed on the first surface 211 of the transparent substrate 21. The second electrode 24 is disposed above the first electrode 22. The organic light-emitting portion 23 is disposed between the first electrode 22 and the second electrode 24. The mirror plate 25 is assembled with the second surface 212 of the transparent substrate 21.

In the present embodiment, the transparent substrate 21 has a first surface 211 and a second surface 212 opposite to the first surface 211. The transparent substrate 21 can be a flexible or a rigid substrate. The transparent substrate 21 can also be a plastic or glass substrate. In particular, the flexible substrate or plastic substrate can be made of polycarbonate (PC), polyester (PET), cyclic olefin copolymer (COC), or metallocene-based cyclic olefin copolymer (mCOC).

Referring to FIG. 5, the first electrode 22 is disposed on the first surface 211 of the transparent substrate 21. In this embodiment, the first electrode 22 is disposed on the first surface 211 by a sputtering method or an ion plating method. The first electrode 22 is usually used as an anode and made of a transparent conductive metal oxide, such as indium-tin oxide (ITO), aluminum-zinc oxide (AZO), or indium-zinc oxide (IZO).

Furthermore, the organic light-emitting portion 23 of the current embodiment is sandwiched between the first electrode 22 and the second electrode 24. The organic light-emitting portion 23 usually contains a hole injection layer, a hole transporting layer, an emitting layer, an electron transporting layer, and an electron injection layer (not shown). The hole injection layer is mainly composed of copper phthalocyanine (CuPc), the hole transporting layer is mainly composed of 4,4′-bis[N-(1-naphthyl)-N-phenylamino]biphenyl (NPB), the electron injection layer is mainly composed of lithium fluoride (LiF), and the electron transporting layer is mainly composed of tris(8-quinolinato-N1,08)-aluminum (Alq). Each layer of the organic light-emitting portion 23 can be disposed on the first electrode 22 by utilizing evaporation, spin coating, ink jet printing, or printing. In addition, the light emitted from the organic light-emitting portion 23 can be blue, green, red, white or other monochromatic light, or a color light as a combination of monochromatic lights.

With reference to FIG. 5, the second electrode 24 is disposed above the first electrode 22. In the embodiment, the second electrode 24 is disposed on the organic light-emitting portion 23 by evaporation or sputtering. The material of the second electrode 24 can be aluminum, calcium, and magnesium-silver alloys. Of course, the material of the second electrode 24 can also be aluminum/lithium fluoride, or silver.

The mirror plate 25, as shown in FIG. 5, is assembled with the second surface 212 of the transparent substrate 21. In this embodiment, the mirror plate 25 comprises a transparent plate 251 and a semi-reflecting layer 252. The semi-reflecting layer 252 is disposed on the transparent plate 251. As shown in FIG. 5, the semi-reflecting layer 252 is combined with the second surface 212 of the transparent substrate 21. Alternatively, the transparent plate 251, as shown in FIG. 6, can be disposed between the semi-reflecting layer 252 and the transparent substrate 21.

In the current embodiment, the mirror plate 25 and the transparent substrate 21 can be assembled by adhesive or glue. They can also be assembled by an additional assembling element (not shown), which relatively fixes the mirror plate 25 and the transparent substrate 21. In this case, the screen size and shape of the mirror plate 25 can be adjusted according to the practical application.

In the embodiment, the semi-reflecting layer 252 can be disposed on the transparent plate 251 by evaporating, sputtering, ion plating, or attaching. The semi-reflecting layer 252 is made of a metal or dielectric material. The light transmittance of the semi-reflecting layer 252 is approximately between 10% and 90%.

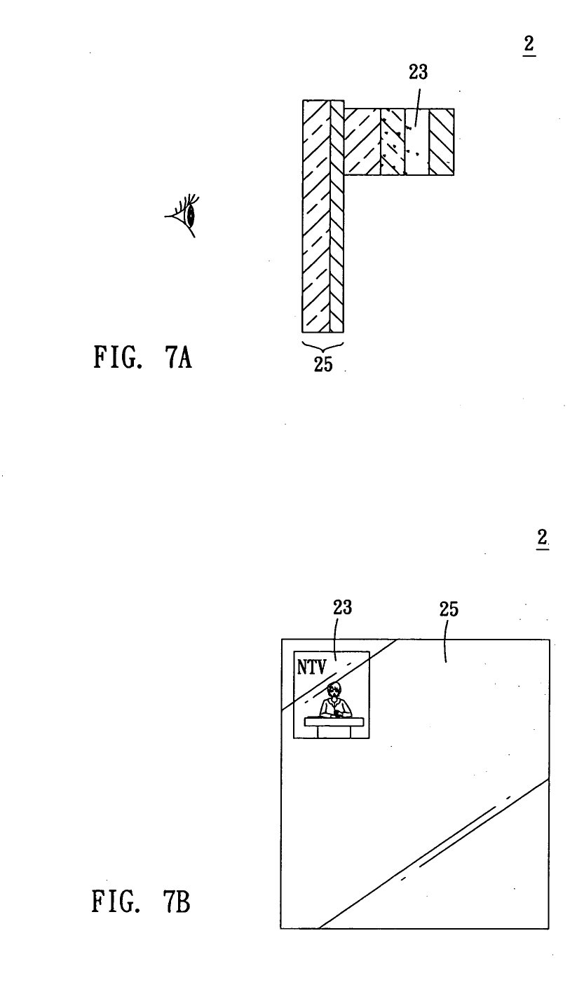

With reference to FIGS. 7A and 7B, when the organic light-emitting portion 23 of the invention emits light, the user can figure out the screen display by the display apparatus with a mirror function 2, such as characters, pictures or images. When the organic light-emitting portion 23 does not emit light, the user can see only the reflected image, such as the reflected image showing what behind the user.

Of course, the invention can be adjusted properly for the practical application. As shown in FIG. 7A, when the area of the mirror plate 25 is larger than that of the organic light-emitting portion 23, the user can both catch the displayed screen image and the reflected image caused by the mirror function. For example, when using a dressing table, the user can watch a TV program, such as news, at the same time (as shown in FIG. 7B). Since the organic electroluminescence (OEL) display has an advantage of no limitation of viewing angle, the practical application of the display apparatus with a mirror function 2 is broadened.

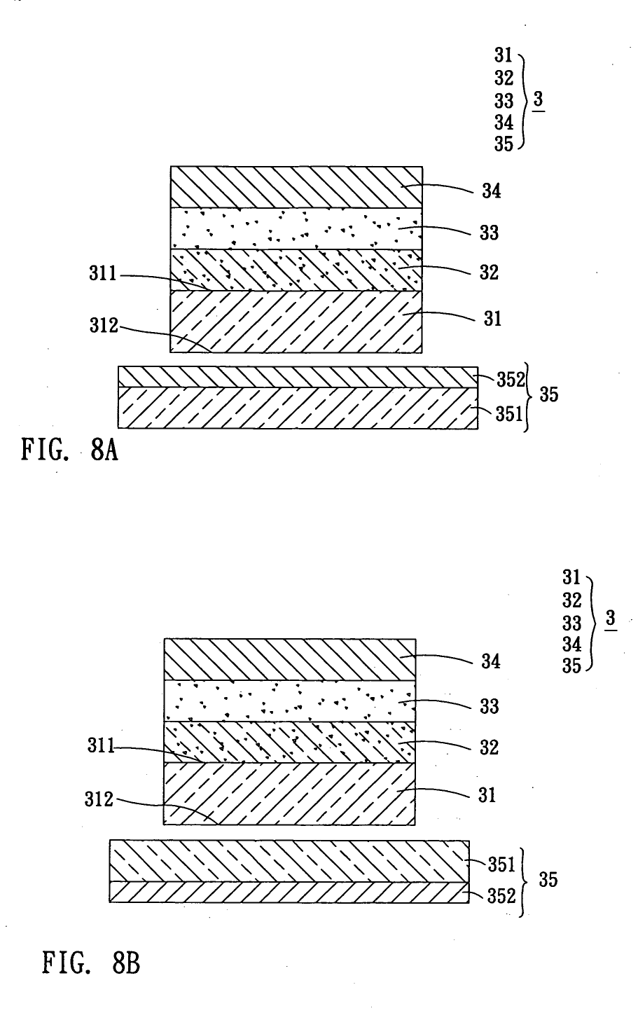

Referring to FIGS. 8A and 8B, a display apparatus with a mirror function 3 according to a fifth embodiment of the invention comprises a transparent substrate 31, a first electrode 32, an organic light-emitting portion 33, a second electrode 34, and a mirror plate 35. In this embodiment, the transparent substrate 31 has a first surface 311 and a second surface 312 opposite to the first surface 311. The first electrode 32 is disposed on the first surface 311 of the transparent substrate 31. The second electrode 34 is disposed above the first electrode 32. The organic light-emitting portion 33 is disposed between the first electrode 32 and the second electrode 34. The mirror plate 35 is assembled with the second surface 312 of the transparent substrate 31.

Some elements of the display apparatus with a mirror function 3 are similar to those of the display apparatus with a mirror function 2 of the fourth embodiment, and are not described again herein below.

In the embodiment, the mirror plate 35 is provided adjacent to the second surface 312 of the transparent substrate 31, and the mirror plate 35 and the transparent substrate 31 are relatively fixed by an additional assembling element (not shown). The mirror plate 35 comprises a transparent plate 351 and a semi-reflecting layer 352. The semi-reflecting layer 352 is disposed on the transparent plate 351. As shown in FIG. 8A, the semi-reflecting layer 352 is positioned adjacent to the second surface 312 of the transparent substrate 31. Alternatively, the transparent plate 351, as shown in FIG. 8B, is disposed between the semi-reflecting layer 352 and the transparent substrate 31.

A display apparatus with a mirror function according to a sixth embodiment of the invention comprises a transparent substrate, a first electrode, an organic light-emitting zone, a second electrode, and a mirror plate. In this embodiment, the transparent substrate has a first surface and a second surface opposite to the first surface. The first electrode is disposed on the first surface of the transparent substrate. The second electrode is disposed above the first electrode. The organic light-emitting portion is disposed between the first electrode and the second electrode. The mirror plate is assembled with the second surface of the transparent substrate.

Some elements of the display apparatus with a mirror function of the sixth embodiment are similar to those of the display apparatus with a mirror function 2 of the fourth embodiment, and are not described again herein below.

Furthermore, the organic light-emitting zone of the current embodiment is disposed on the first electrode. The organic light-emitting zone can be an organic electroluminescence (OEL) layer or an electroluminescence (EL) layer. In this case, the organic light-emitting zone usually contains a hole injection layer, a hole transporting layer, an emitting layer, an electron transporting layer, and an electron injection layer (not shown). The hole injection layer is mainly composed of copper phthalocyanine (CuPc), the hole transporting layer is mainly composed of 4,4′-bis[N-(1-naphthyl)-N-phenylamino]biphenyl (NPB), the electron injection layer is mainly composed of lithium fluoride (LiF), and the electron transporting layer is mainly composed of tris(8-quinolinato-N1,08)-aluminum (Alq). Each layer of the organic light-emitting zone can be disposed on the first electrode by utilizing evaporation, spin coating, ink jet printing, or printing. In addition, the light emitted from the organic light-emitting zone can be blue, green, red, white or other monochromatic light, or a color light as a combination of monochromatic lights.

Moreover, a display apparatus with a mirror function according to a seventh embodiment of the invention comprises a transparent substrate, a first electrode, an organic light-emitting zone, a second electrode, and a mirror plate. In the embodiment, the transparent substrate has a first surface and a second surface opposite to the first surface. The first electrode is disposed on the first surface of the transparent substrate. The second electrode is disposed above the first electrode. The organic light-emitting zone is disposed between the first electrode and the second electrode. The mirror plate is assembled with the second surface of the transparent substrate. The light-emitting zone of the embodiment is an emitting layer.

The light-emitting zone of the display apparatus with a mirror function of the seventh embodiment is similar to that of the display apparatus with a mirror function of the sixth embodiment, and is not described again herein below.

Some elements of the display apparatus with a mirror function of the seventh embodiment are similar to those of the display apparatus with a mirror function 2 of the third embodiment, and are not described again herein below.

The light-emitting zone is an electroluminescence zone, which can be a single-layer or a multi-layer of an electroluminescence layer, an emitting media, and/or the likes. The emitting media, for example, is not limited to and is electroluminescence gas, or any other emitting media, which is excited by the electroluminescence gas.

In summary, the display apparatus with a mirror function of the invention combines the display and the mirror plate with semi-reflecting layer. When the light-emitting zone emits light, the display apparatus with a mirror function presents the function of displaying; otherwise, when the light-emitting zone does not emit light, the display apparatus with a mirror function presents the function of reflecting images. Compared with the conventional technology, the invention integrates the flat structures of the reflecting mirror plate and display, so that the display apparatus with a mirror function has dual functions of displaying and image reflecting. Therefore, the application field of the mirror is broadened, and the display apparatus with a mirror function is more convenient for user operations. Furthermore, the manufacturing process of the display apparatus with a mirror function of the invention is simpler and not expensive. Therefore, the invention is suitable for mass production.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A display apparatus with a mirror function, comprising:
a display, which comprises a transparent substrate; and
a semi-reflecting layer, which is disposed on one side of the transparent substrate.

2. The display apparatus of claim 1, wherein the transparent substrate has a first surface and a second surface opposite the first surface.

3. The display apparatus of claim 2, wherein the semi-reflecting layer is disposed on the first surface of the transparent substrate.

4. The display apparatus of claim 2, wherein the semi-reflecting layer is disposed on the second surface of the transparent substrate.

5. The display apparatus of claim 1, wherein the transparent substrate comprises at least one selected from the group consisting of a flexible substrate, a rigid substrate, a plastic substrate and a glass substrate.

6. The display apparatus of claim 1, wherein the semi-reflecting layer comprises a metal.

7. The display apparatus of claim 1, wherein the semi-reflecting layer comprises a dielectric material.

8. The display apparatus of claim 1, wherein the semi-reflecting layer has a radiation transmittance between about 10% and 90%.

9. The display apparatus of claim 1, wherein the display comprises at least one selected from the group consisting of an organic electroluminescent display, an inorganic electroluminescent display, a light-emitting diode display, a liquid crystal display, a plasma display panel, a vacuum fluorescent display, a field emission display, and an electro-chromic display.

10. A display apparatus with a mirror function, comprising:
a transparent substrate;
a first electrode, which is disposed on the transparent substrate;
a second electrode, which is disposed above the first electrode;
a light-emitting zone, which is disposed between the first electrode and the second electrode; and
a mirror plate, which is disposed on one side of the transparent substrate opposite to another side of the transparent substrate connected to the first electrode.

11. The display apparatus of claim 10, wherein the light-emitting zone comprises at least one organic electroluminescence layer.

12. The display apparatus of claim 10, wherein the light-emitting zone comprises at least one electroluminescence layer or emitting media.

13. The display apparatus of claim 10, wherein the mirror plate is assembled with the transparent substrate.

14. The display apparatus of claim 10, wherein the mirror plate is disposed adjacent to the transparent substrate.

15. The display apparatus of claim 10, wherein the mirror plate comprises a transparent plate and a semi-reflecting layer, and the semi-reflecting layer is disposed on the transparent plate.

16. The display apparatus of claim 15, wherein the semi-reflecting layer is positioned between the transparent substrate and the transparent plate.

17. The display apparatus of claim 15, wherein the transparent plate is disposed between the transparent substrate and the semi-reflecting layer.

18. The display apparatus of claim 15, wherein the semi-reflecting layer is made of metal.

19. The display apparatus of claim 15, wherein the semi-reflecting layer is made of a dielectric material.

20. The display apparatus of claim 15, wherein the semi-reflecting layer has a light transmittance between about 10% and 90%.

21. The display apparatus of claim 10, wherein the transparent substrate is selected from at least one of a flexible substrate, a rigid substrate, a plastic substrate, and a glass substrate.

22. The display apparatus of claim 10, wherein the first electrode is an electrical conductive metal oxide electrode layer.

23. The display apparatus of claim 10, wherein the second electrode is an electrode layer made of a material selected from at least one of aluminum, calcium, and magnesium-silver alloys.
